(19) United States
(12) Patent Application Publication
(10) Pub. No.: US 2025/0358889 A1
(43) Pub. Date: Nov. 20, 2025

(54) SERVICE DIFFERENTIATION FOR RRC INACTIVE STATE

(71) Applicant: T-Mobile USA, Inc., Bellevue, WA (US)

(72) Inventor: Anthony Punzal DEL ROSARIO, Sammamish, WA (US)

(21) Appl. No.: 18/666,770

(22) Filed: May 16, 2024

(51) Int. Cl. H04W 76/27; H04W 36/08

(52) U.S. Cl. CPC H04W 76/27; H04W 36/08

(57) ABSTRACT

Solutions are disclosed that provide service differentiation to prioritize which user equipment (UE) is assigned to the radio resource control (RRC) inactive state, due to limitations on the number of UEs that a base station can support in that state. If a UE has an ongoing packet session (e.g., protocol data unit, PDU, session) meeting selection criteria, that UE is prioritized for the RRC Inactive state. UEs that do not have an ongoing packet session meeting the selection criteria are permitted to go to the RRC Idle state. Since resuming the RRC Connected state from the RRC Inactive state is faster than establishing the RRC Connected state from the RRC Idle state, the UEs having the packet session meeting the selection criteria experience less packet delay when resuming data transmission after a period of inactivity. The selection criteria may thus be generally related to packet delay budgets.

### BACKGROUND

In cellular mobile communications, user equipment (UE) exchange control and configuration messages with the serving base station, such as a gNode-B (gNB), using an RRC (Radio Resource Control) connection with messages defined by the RRC Protocol. Messages using this RRC connection are used by the UE and gNB to allocate resources for transmitting user data, controlling handovers, controlling network registration, reporting air interface conditions, and other tasks. However, there are scenarios in which a UE has nothing to transmit, is not receiving data, and so does not require an active communication channel (e.g., an active RRC connection) to the base station. In such scenarios, maintaining an active communication channel may be wasteful of UE battery power and network radio resources.

To improve efficiency, an RRC Idle state is available, in which the RRC connection is terminated, along with other defined communication paths to the core network. While in the RRC Idle state, the UE is able to initiate a restart of the RRC Connection when it needs to transmit data to the network or respond to paging from the network. Unfortunately, restarting the RRC Connection requires time, and may interfere with packet delay latency requirements for certain types of communications, such as real-time gaming, remote control, virtual reality (VR) and augmented reality (AR), mission critical communications, autonomous vehicle communications, and vehicle to everything (V2X) communication.

### SUMMARY

The following summary is provided to illustrate examples disclosed herein, but is not meant to limit all examples to any particular configuration or sequence of operations.

Solutions are disclosed that provide service differentiation for the radio resource control (RRC) inactive state. Examples detect an expiration of a first inactivity timer for a first user equipment (UE); determine that the first UE supports a radio resource control (RRC) Inactive state; determine that the first UE has an ongoing packet session meeting selection criteria for the RRC Inactive state; and based on at least the first UE supporting the RRC Inactive state and the first UE having the ongoing packet session meeting the selection criteria for the RRC Inactive state, and further based on at least the expiration of the first inactivity timer, instruct the first UE, by a first base station serving the first UE, to enter the RRC Inactive state.

### BRIEF DESCRIPTION OF THE DRAWINGS

The disclosed examples are described below with reference to the accompanying drawing figures listed below, wherein:

FIG. 1 illustrates an exemplary architecture that advantageously provides service differentiation for the radio resource control (RRC) Inactive state;

FIG. 2 illustrates various RRC states in which a user equipment (UE) may be in examples of the architecture of FIG. 1;

FIG. 3 illustrates a flowchart of exemplary operations associated with a UE transitioning states, as may occur when using examples of the architecture of FIG. 1;

FIG. 4 illustrates a message sequence diagram of messages, associated with the flowchart of FIG. 3, that may occur in examples of the architecture of FIG. 1;

FIG. 5 illustrates another flowchart of exemplary operations associated with a UE transitioning states, as may occur when using examples of the architecture of FIG. 1;

FIG. 6 illustrates a message sequence diagram of messages, associated with the flowchart of FIG. 5, that may occur in examples of the architecture of FIG. 1;

FIGS. 7 and 8 illustrate additional flowcharts of exemplary operations associated with the architecture of FIG. 1; and

FIG. 9 illustrates a block diagram of a computing device suitable for implementing various aspects of the disclosure.

Corresponding reference characters indicate corresponding parts throughout the drawings, where practical. References made throughout this disclosure. relating to specific examples, are provided for illustrative purposes, and are not meant to limit all implementations or to be interpreted as excluding the existence of additional implementations that also incorporate the recited features.

### DETAILED DESCRIPTION

Solutions are disclosed that provide service differentiation to prioritize which user equipment (UE) is assigned to the radio resource control (RRC) inactive state, due to limitations on the number of UEs that a base station can support in that state. If a UE has an ongoing packet session (e.g., protocol data unit, PDU, session) meeting selection criteria, that UE is prioritized for the RRC Inactive state. UEs that do not have an ongoing packet session meeting the selection criteria are permitted to go to the RRC Idle state. Since resuming the RRC Connected state from the RRC Inactive state is faster than establishing the RRC Connected state from the RRC Idle state, the UEs having the packet session meeting the selection criteria experience less packet delay when resuming data transmission after a period of inactivity. The selection criteria may thus be generally related to packet delay budgets.

Aspects of the disclosure thus improve the performance of cellular networks by prioritizing UEs for the RRC Inactive state based on at least whether the UE has an ongoing packet session that is more sensitive to delay. This reduces negative impacts experienced by network users, by permitting the UEs with delay-critical connections to have a rapid recovery from inactivity, while permitting UEs without such delay-critical connections to experience the battery savings of the RRC Idle state. These advantageous results are accomplished, at least in part, by based on at least the UE supporting an RRC Inactive state and the UE having the ongoing packet session meeting selection criteria for the RRC Inactive state, and further based on at least an expiration of an inactivity timer, instructing the UE, by a base station serving the UE, to enter the RRC Inactive state.

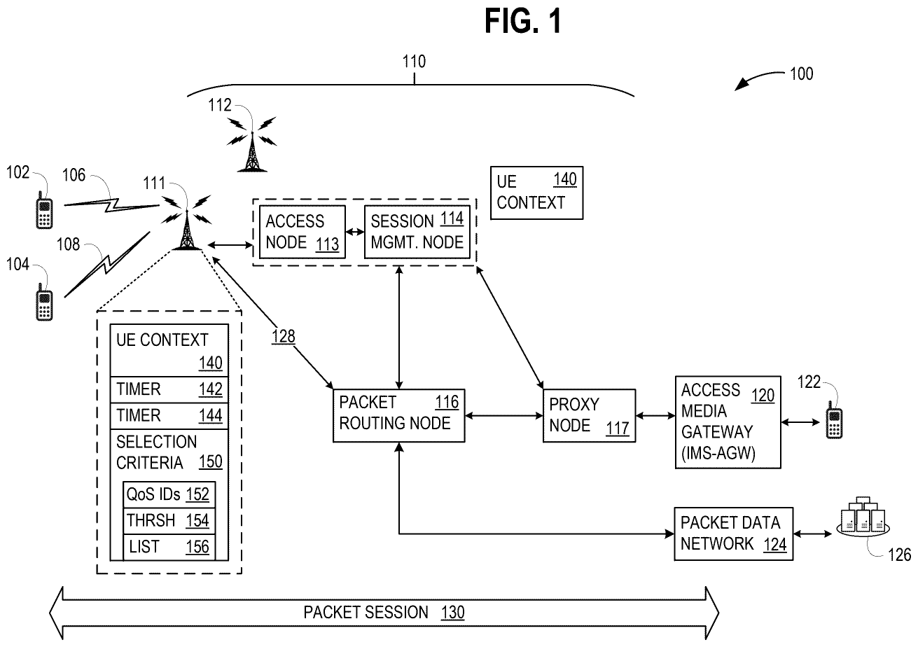

With reference now to the figures, FIG. 1 illustrates an exemplary architecture 100 that advantageously provides service differentiation for the RRC Inactive state. A wireless network 110 is illustrated that is serving a UE 102 and a UE 104. UE 102 and UE 104 may each be an enhanced Mobile Broadband (eMBB) or cellphone, a fixed wireless access (FWA), internet of things (IoT) device, machine-to-machine (M2M) communication device, a personal computer (PC, e.g., desktop, notebook, tablet, etc.) with a cellular modem, or another telecommunication devices capable of using a wireless network. In the scene depicted in FIG. 1, UE 102 is using wireless network 110 for a packet session 130 (e.g., a protocol data unit, PDU, session) to reach a network resource 126 (e.g., a website) across an external packet data network 124 (e.g., the internet). In some scenarios, UE 102 may use wireless network 110 for a phone call with another UE 122. Wireless network 110 may be a cellular network such as a fifth generation (5G) network, a fourth generation (4G) network, or another cellular generation network. In some contexts, 5G is also referred to as new radio (NR), and standalone 5G, which is a full 5G implementation that does not rely on 4G technology for some functionality, may be referred to SA NR.

UE 102 uses an air interface 106 to communicate with a base station 111 of wireless network 110, such that base station 111 is the serving base station for UE 102 (providing the serving cell). UE 104 similarly uses an air interface 108 to communicate with base station 111, such that base station 111 is also the serving base station for UE 104. Wireless network 110 is shown with another base station 112, although some examples of wireless network 110 may have a larger number of base stations. In some scenarios, base stations 111 and 112 may each be referred to as a radio access network (RAN), and is located at a radio site. Wireless network 110 has an access node 113, a session management node 114, and other components (not shown). Wireless network 110 also has a packet routing node 116 and a proxy node 117. Access node 113 and session management node 114 are within a control plane of wireless network 110, and packet routing node 116 is within a data plane (a.k.a. user plane) of wireless network 110. Together, access node 113, session management node 114, and packet routing node 116 for a core network for wireless network 110.

Base stations 111 and 112 are each is in communication with access node 113 and packet routing node 116. Access node 113 is in communication with session management node 114, which is in communication with packet routing node 116 and proxy node 117. Packet routing node 116 is in communication with proxy node 117 and packet data network 124. In some 5G examples, base station 111 comprises a gNodeB (gNB), access node 113 comprises an access mobility function (AMF), session management node 114 comprises a session management function (SMF), and packet routing node 116 comprises a user plane function (UPF).

In some 4G examples, base station 111 comprises an eNodeB (eNB), access node 113 comprises a mobility management entity (MME), session management node 114 comprises a system architecture evolution gateway (SAEGW) control plane (SAEGW-C), and packet routing node 116 comprises an SAEGW-user plane (SAEGW-U). In some examples, proxy node 117 comprises a proxy call session control function (P-CSCF) in both 4G and 5G.

In some examples, wireless network 110 has multiple ones of each of the components illustrated, in addition to other components and other connectivity among the illustrated components. In some examples, wireless network 110 has components of multiple cellular technologies operating in parallel in order to provide service to UEs of different cellular generations. For example, wireless network 110 may use both a gNB and an eNB co-located at a common cell site. In some examples, multiple cells may be co-located at a common cell site (or radio site), and may be a mix of 5G and 4G.

Proxy node 117 is in communication with an internet protocol (IP) multimedia system (IMS) access gateway (IMS-AGW) 120 within an IMS, in order to provide connectivity to other wireless (cellular) networks, such as for a call with a UE 122 or a public switched telephone system (PSTN, also known as plain old telephone system, POTS). In some examples, proxy node 117 may be considered to be within the IMS and/or the core network. UE 102 reaches network resource 126 using packet data network 124 (or the IMS, in some examples). Data packets of data traffic 128 to/from UE 102 (e.g., of packet session 130) pass through at least base station 111 and packet routing node 116 on their way from/to packet data network 124 or IMS-AGW 120 (via proxy node 117).

As described more fully below, in relation to the other figures, base station 111 maintains a UE context 140 for UE 102, which is shared with the core network, such as access node 113. UE context 140 defines connections between UE 102 and the core network (e.g., between UE 102 and access node 113 and also packet routing node 116), and other information necessary to maintain services for UE 102. Examples include UE state information, security information, UE capability information, and the identities of the UE-associated logical connections. Base station 111 has an inactivity timer 142 for UE 102 and an inactivity timer 144 for UE 104. Inactivity timer 142 and 144 may be on the order of seconds, such as 5 seconds or 10 seconds.

Base station 111 also has selection criteria 150 that is used to determine whether a UE is eligible to be prioritized for RRC Inactive. Selection criteria 150 may include a set of quality of service (QoS) identifiers 152, specify a packet delay threshold 154, and/or have an RRC Inactive state selection list 156 of which specific QoS identifiers are used to prioritize a UE for RRC Inactive. In 5G, QoS identifiers comprises 5G QoS identifier (5QI) values, in 4G, QoS identifiers comprises 4G QoS class identifier (QCI) values. In some examples, packet delay threshold 154 is 50 milliseconds (ms) or 100 ms, and/or RRC Inactive state selection list 156 has predetermined QoS identifiers designated as mission critical and/or for use by autonomous vehicles and/or vehicle to everything (V2X) communication;

Although FIG. 1 and some of the following figures are described using an example of a cellular network, it should be understood that the teachings herein are applicable to other types of wireless networks. To benefit from the teachings herein, another type of wireless network should offer two battery-saving states, one of which offers faster recovery times for UE, and is able to identify communication session types according to packet delay requirements. With such a configuration, the teachings herein may extend to the other types of wireless network.

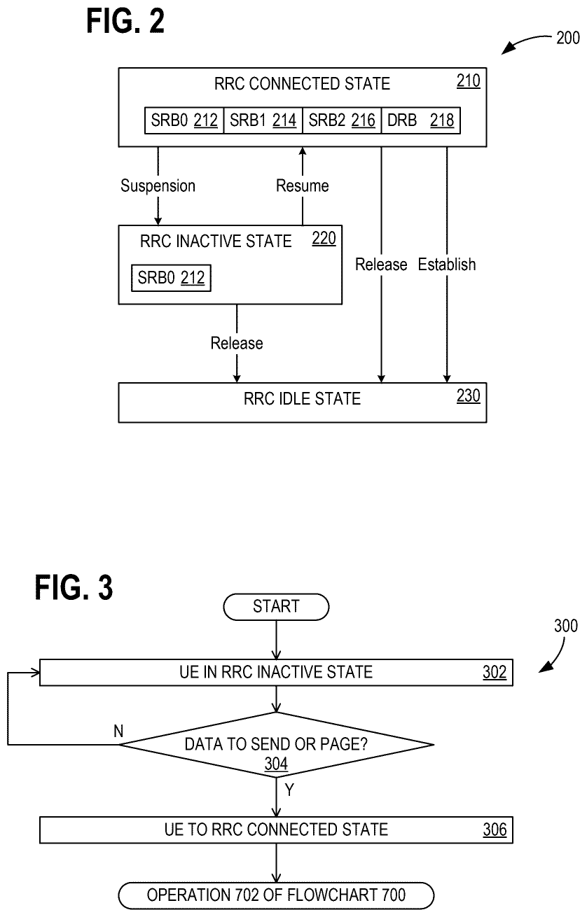

FIG. 2 illustrates a set 200 of various RRC states in which UE 102 and UE 104 may be in at various times. A UE in an RRC connected state 210 has a set of radio bearers that enable the UE to transmit and receive data. Examples include multiple SRBs (Signaling Radio Bearers), such as an SRB0 212, an SRB1 214, an SRB2 216, and SRB3 (not shown) for special cases, and a DRB (Data Radio Bearer) 218.

SRB0 212 is a common control channel (CCCH) logical channel, and may be used for (on the downlink, DL) RRC Connection Setup, RRC Connection Reject, RRC Connection Re-establishment, and RRC Connection Re-establishment reject; and (or the uplink, UL) RRC Connection Request and RRC Connection Re-establishment Request. SRB1 214 is a dedicated control channel (DCCH) logical channel, and may be used for (on the DL) RRC Connection Reconfiguration, RRC Connection Release, Security Mode Command, UE Capability Inquiry, Mobility signaling, Handover signaling, and DL information transfer (if SRB2 216 is not available); and (on the UL) RRC Connection Setup Complete, RRC Connection Reconfiguration Complete, RRC Connection Re-establishment Complete, Security Mode Complete, Security Mode Failure, UE Capability information, Handover signaling, Measurement report, Handover signaling, and UL Information Transfer (if SRB2 216 is not available). SRB2 216 is another DCCH logical channel, and may be used for DL Information Transfer and UL Information Transfer. DRB 218 is used for voice service data packets.

When a UE is suspended from RRC connected state 210 to an RRC Inactive state 220, all SRBs, except SRB0 212 are terminated, along with DRB 218. UE context 140 is kept, and so will not need to be reconstructed. When the UE resumes RRC connected state 210 from RRC Inactive state 220, SRB1 214, SRB2 216, and DRB 218 may be re-established. When a UE is released from RRC Inactive state 220 to an RRC Idle state 230, SRB0 212 is terminated.

When a UE is released from RRC connected state 210 to RRC Idle state 230, all SRBs, including SRB0 212 are terminated, along with DRB 218. When the UE establishes (or re-establishes) RRC connected state 210 from RRC Idle state 230, it is necessary to establish SRB0 212, and only then SRB1 214, SRB2 216, and DRB 218 may be re-established. This is why re-establishing RRC connected state 210 from RRC Idle state 230 takes longer than resuming RRC connected state 210 from RRC Inactive state 220.

A base station typically has a limit on the number of UEs that may be held in RRC Inactive state 220 (e.g., 2,000 UEs). When this limit is exceeded, without a prioritization scheme such as is introduced here, a round-robin solution (or another process) is used to select which UEs may be retained in RRC Inactive state 220, and which must go to RRC Idle state 230, and which may not align with the delay needs of the UEs. Thus (absent the teachings herein), the advantages of the RRC Inactive state 220 may not be available to the UEs that need it, and may instead be wasted on UEs that do not have such an acute requirement.

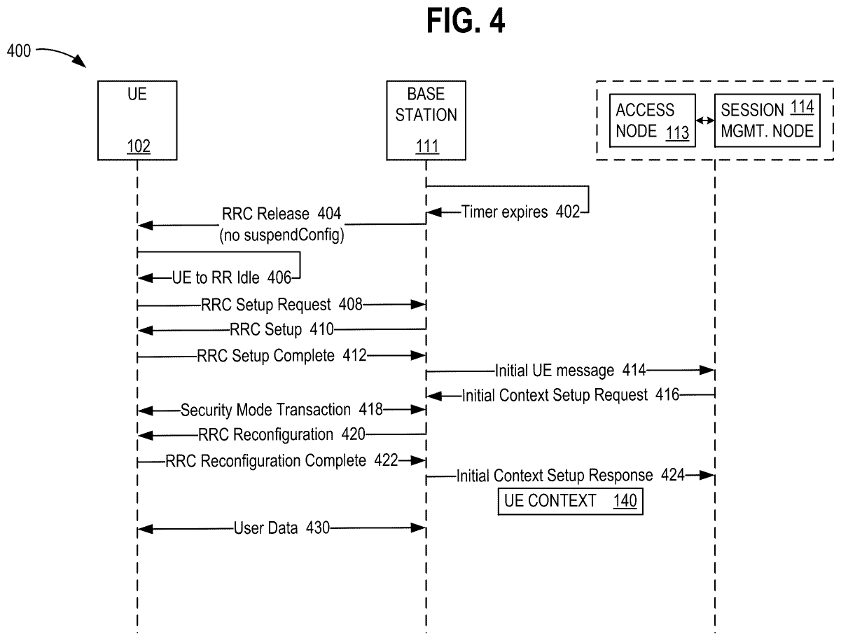

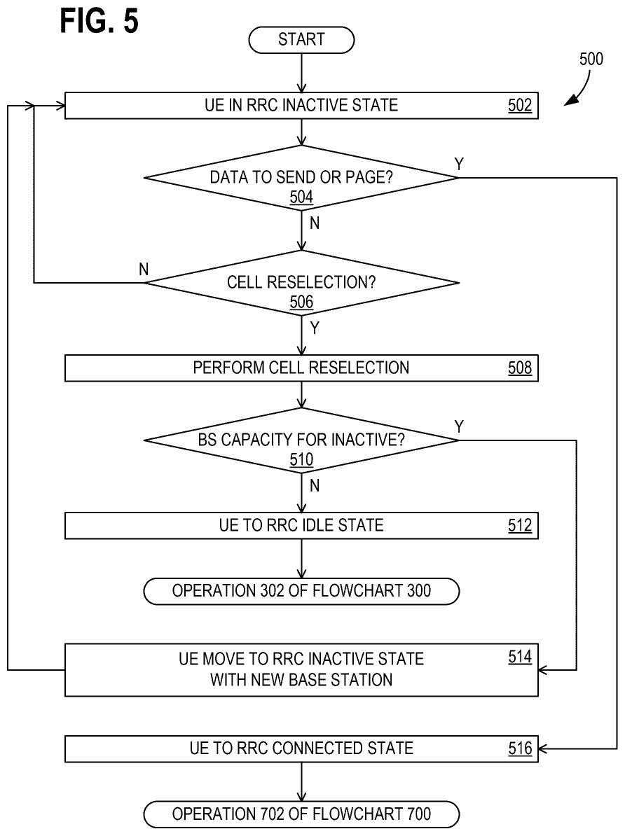

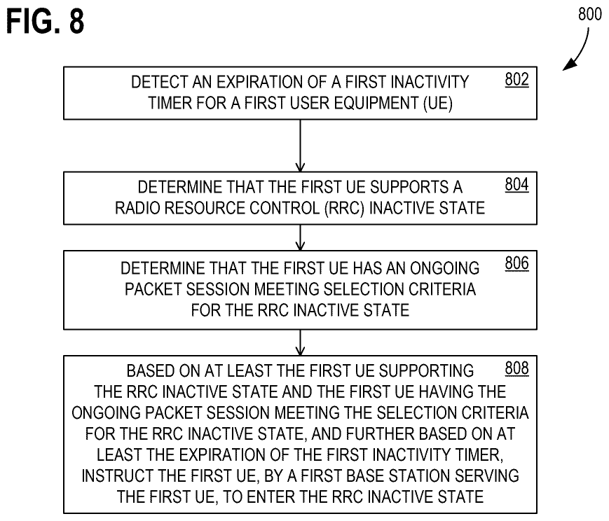

FIG. 3 illustrates a flowchart 300 of exemplary operations associated with a UE transitioning from RRC Idle state 230 to RRC Connected state 210. Flowchart 300 is described for UE 102, but may also be performed for UE 104. UE 102 is in RRC Idle state 230 in box 302. Decision operation 304 determines whether UE 102 has data to transmit or needs to respond to a network page. If not, flowchart 300 returns to box 302. If UE 102 does have data to transmit or needs to respond to a network page, flowchart 300 moves to operation 306, in which RRC Connected state 210 is established for UE 102, according to a message sequence diagram 400 of FIG. 4, starting with message 408. Flowchart 300 then transitions to box 702 of a flowchart 700 (shown in FIG. 7).

Referring now to FIG. 4, message sequence diagram 400 starts with inactivity timer 142 expiring, which is shown as message 402. Base station 111 then transmits an RRC Release message 404 (without a suspendConfig instruction) to put UE 102 into RRC Idle state 230, which is shown as message 406.

Returning from RRC Idle state 230 to RRC Connected state 210 is performed using messages 408-424. UE 102 transmits RRC Setup Request 408 to base station 111, which responds with RRC Setup 410. Upon completion of the RRC setup, UE 102 responds with RRC Setup Complete 412.

Base station 111 then informs the core network (e.g., at least access node 113 and/or session management node 114) that UE 102 is returning to RRC Connected state 210 using Initial UE message 414. The core network responds with Initial Context Setup Request 416, which instructs base station 111 to create UE context 140. Base station initiates Security Mode Transaction 418 with UE 102, then transmits RRC Reconfiguration 420 to UE 102. Upon completion, UE 102 responds with RRC Reconfiguration Complete 422. Base station 111 then forwards UE context 140 to the core network (e.g., at least to access node 113) using Initial Context Setup Response 424. User Data 430 then is able to flow to/from UE 102 on packet session 130.

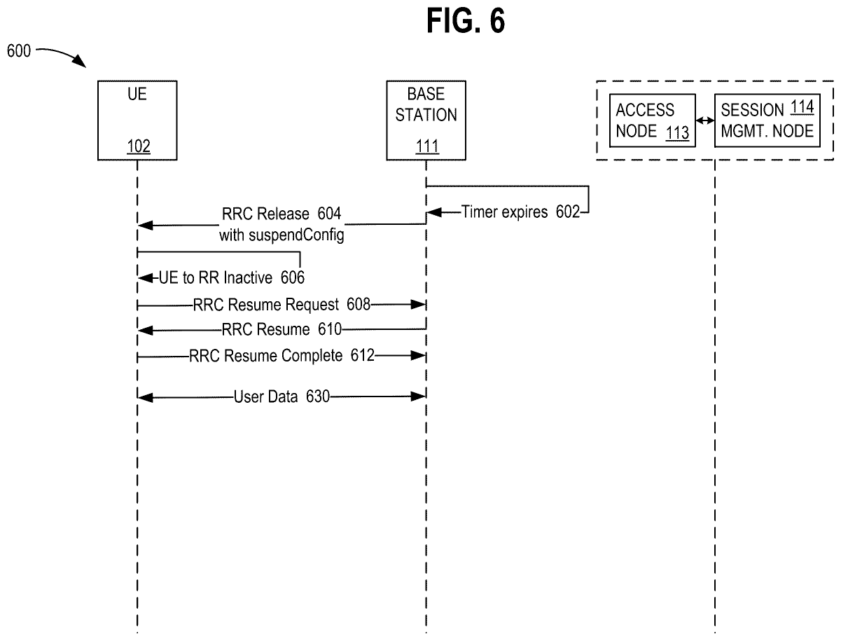

FIG. 5 illustrates a flowchart 500 of exemplary operations associated with a UE transitioning from RRC Inactive state 220 to RRC Connected state 210. Flowchart 500 is described for UE 102, but may also be performed for UE 104. UE 102 is in RRC Inactive state 220 in box 502. Decision operation 504 determines whether UE 102 has data to transmit or needs to respond to a network page. If not, decision operation 506 determines whether there is to be a cell reselection from base station 111 to base station 112. If not, flowchart 500 returns to box 502.

If there is a cell reselection, operation 508 performs a cell reselection of UE 102 from base station 111 to base station 112. The state of UE 102 (RRC Inactive state 220) is reported to base station 112 during the cell reselection. Decision operation 510 determines whether base station 112 has capacity to support UE 102 in RRC Inactive state 220. If not, base station 112 instructs UE 102 to enter RRC Idle state 230 (i.e., base station 112 releases UE 102 to RRC Idle state 230) in operation 512. Flowchart 500 then transitions to box 302 of flowchart 300. If there is capacity, based on at least UE 102 having been in RRC Inactive state 220 with base station 111, base station 112 instructs UE 102 to enter RRC Inactive state 220 in operation 514. Flowchart 500 then returns to box 502.

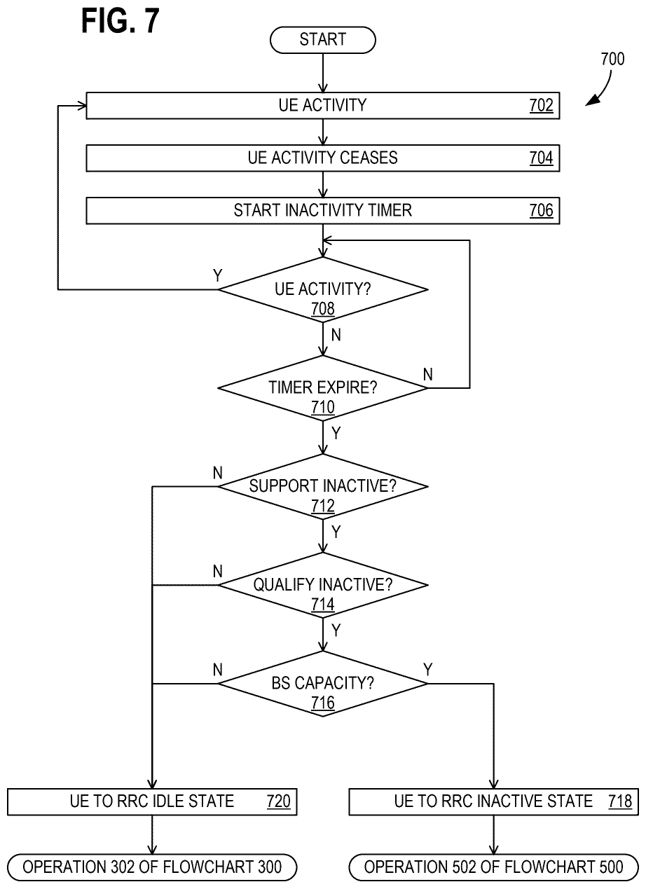

If UE 102 does have data to transmit or needs to respond to a network page, flowchart 500 moves to operation 516, in which RRC Connected state 210 is resumed for UE 102, according to a message sequence diagram 600 of FIG. 6, starting with message 608. Flowchart 500 then transitions to box 702 of flowchart 700 (of FIG. 7).

Referring now to FIG. 6, message sequence diagram 600 starts with inactivity timer 142 expiring, which is shown as message 602. Base station 111 then transmits an RRC Release message 604 (with a suspendConfig instruction) to put UE 102 into RRC Inactive state 220, which is shown as message 606.

Resuming from RRC Inactive state 220 to RRC Connected state 210 is performed using messages 608-612. UE 102 transmits RRC Resume Request 608 to base station 111, which responds with RRC Resume 610. Upon completion, UE 102 responds with RRC Resume Complete 412. Because UE context 140 was retained while UE 102 was in RRC Inactive state 220, it does not need to be reconstructed. User Data 630 then is able to flow to/from UE 102 on packet session 130 sooner than if UE 102 was instead recovering from RRC Idle state 230.

FIG. 7 illustrates a flowchart 700 of exemplary operations associated with architecture 100. In some examples, at least a portion of flowchart 700 may be performed using one or more computing devices 1700 of FIG. 17. Flowchart 700 commences with UE activity occurring for UE 102 in operation 702. UE activity ceases for UE 102 at box 704, and operation 706 starts inactivity timer 142.

Decision operation 708 determines whether UE activity has resumed for UE 102. If so, flowchart 700 returns to box 702. Otherwise, decision operation 710 determines whether inactivity timer 142 has expired. If inactivity timer 142 has not expired, flowchart 700 returns to decision operation 708. When decision operation 710 detects expiration of inactivity timer 142, flowchart 700 proceeds to decision operation 712.

In decision operation 712, base station 111 determines whether UE 102 supports RRC Inactive state 220. If not, flowchart 700 moves to operation 720, which is described below. If, however, base station 111 determines that UE 102 supports RRC Inactive state 220 in decision operation 712, flowchart 700 proceeds to decision operation 712.

In decision operation 714, base station 111 determines whether UE 102 has an ongoing packet session 130 meeting selection criteria 150 for RRC Inactive state 220. If not, flowchart 700 moves to operation 720. If, however, base station 111 determines that UE 102 does have an ongoing packet session 130 meeting selection criteria 150 for RRC Inactive state 220 in decision operation 712, flowchart 700 proceeds to decision operation 712, flowchart 700 proceeds to decision operation 716.

In decision operation 716, base station 111 determines whether it has capacity to support UE 102 in RRC Inactive state 220. If not, flowchart 700 moves to operation 720. If, however, base station 111 determines that it does have capacity to support UE 102 in RRC Inactive state 220, operation 718 moves UE 102 to RRC Inactive state 220. That is, based on at least UE 102 supporting RRC Inactive state 220 and UE 102 having the ongoing packet session meeting selection criteria 150 for RRC Inactive state 220, and based on at least the expiration of inactivity timer 142, and further based on at least base station 111 having capacity to support UE 102 in RRC Inactive state 220, base station 111 instructs UE 102 to enter RRC Inactive state 220. In some examples, this is accomplished by base station 111 transmitting RRC Release 604 with a suspendConfig instruction. Flowchart 700 then transitions to box 502 of flowchart 500.

In operation 720 (not reached for UE 102 in this example), based on at least a UE not supporting RRC Inactive state 220, or not having an ongoing packet session meeting selection criteria 150 for RRC Inactive state 220, or base station 111 not having capacity to support the UE in RRC Inactive state 220, base station 111 instructs the UE to enter RRC Idle state 220 (e.g., by transmitting RRC Release 404 without a suspendConfig instruction). Flowchart 700 then transitions to box 302 of flowchart 300.

As a further example, a second pass through flowchart 700 is summarily described for UE 104. Decision operation 710 detects expiration of inactivity timer 144 for UE 104, decision operation 712 determines that UE 104 supports RRC Inactive state 220, but decision operation 714 determines that UE 104 does not have an ongoing packet session meeting selection criteria for RRC Inactive state 220. Thus, for UE 104, flowchart 700 does reach operation 720. In operation 720, based on at least UE 104 not having an ongoing packet session meeting selection criteria 150 for RRC Inactive state 220, and further based on at least the expiration of inactivity timer 144, base station 111 instructs UE 104 to enter RRC Idle state 230.

FIG. 8 illustrates a flowchart 800 of exemplary operations associated with examples of architecture 100. In some examples, at least a portion of flowchart 800 may be performed using one or more computing devices 1700 of FIG. 17. Flowchart 800 commences with operation 802, which includes detecting an expiration of a first inactivity timer for a first UE.

Operation 804 includes determining that the first UE supports an RRC Inactive state. Operation 806 includes determining that the first UE has an ongoing packet session meeting selection criteria for the RRC Inactive state. Operation 808 includes, based on at least the first UE supporting the RRC Inactive state and the first UE having the ongoing packet session meeting the selection criteria for the RRC Inactive state, and further based on at least the expiration of the first inactivity timer, instructing the first UE, by a first base station serving the first UE, to enter the RRC Inactive state.

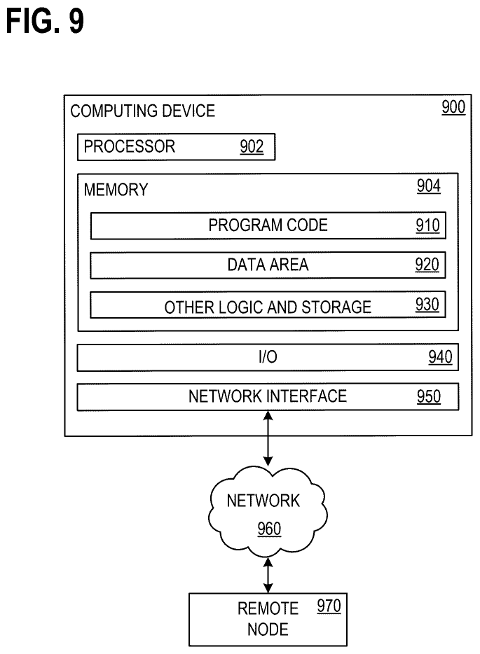

FIG. 9 illustrates a block diagram of computing device 900 that may be used as any component described herein that may require computational or storage capacity. Computing device 900 has at least a processor 902 and a memory 904 that holds program code 910, data area 920, and other logic and storage 930. Memory 904 is any device allowing information, such as computer executable instructions and/or other data, to be stored and retrieved. For example, memory 904 may include one or more random access memory (RAM) modules, flash memory modules, hard disks, solid-state disks, persistent memory devices, and/or optical disks. Program code 910 comprises computer executable instructions and computer executable components including instructions used to perform operations described herein. Data area 920 holds data used to perform operations described herein. Memory 904 also includes other logic and storage 930 that performs or facilitates other functions disclosed herein or otherwise required of computing device 900. An input/output (I/O) component 940 facilitates receiving input from users and other devices and generating displays for users and outputs for other devices. A network interface 950 permits communication over external computer network 960 with a remote node 970, which may represent another implementation of computing device 900. For example, a remote node 970 may represent another of the above-noted nodes within architecture 100.

### Additional Examples

An example system comprises: a processor; and a computer-readable medium storing instructions that are operative upon execution by the processor to: detect an expiration of a first inactivity timer for a first UE; determine that the first UE supports an RRC Inactive state; determine that the first UE has an ongoing packet session meeting selection criteria for the RRC Inactive state; and based on at least the first UE supporting the RRC Inactive state and the first UE having the ongoing packet session meeting the selection criteria for the RRC Inactive state, and further based on at least the expiration of the first inactivity timer, instruct the first UE, by a first base station serving the first UE, to enter the RRC Inactive state.

An example method of wireless communication comprises: detecting an expiration of a first inactivity timer for a first UE; determining that the first UE supports an RRC Inactive state; determining that the first UE has an ongoing packet session meeting selection criteria for the RRC Inactive state; and based on at least the first UE supporting the RRC Inactive state and the first UE having the ongoing packet session meeting the selection criteria for the RRC Inactive state, and further based on at least the expiration of the first inactivity timer, instructing the first UE, by a first base station serving the first UE, to enter the RRC Inactive state.

One or more example computer storage devices has computer-executable instructions stored thereon, which, upon execution by a computer, cause the computer to perform operations comprising: detecting an expiration of a first inactivity timer for a first UE; determining that the first UE supports an RRC Inactive state; determining that the first UE has an ongoing packet session meeting selection criteria for the RRC Inactive state; and based on at least the first UE supporting the RRC Inactive state and the first UE having the ongoing packet session meeting the selection criteria for the RRC Inactive state, and further based on at least the expiration of the first inactivity timer, instructing the first UE, by a first base station serving the first UE, to enter the RRC Inactive state.

Alternatively, or in addition to the other examples described herein, examples include any combination of the following:
the wireless network comprises a cellular network;
determining that the first base station has capacity to support the first UE in the RRC Inactive state;
instructing the first UE to enter the RRC Inactive state is further based on at least the first base station having capacity to support the first UE in the RRC Inactive state;
the selection criteria for the RRC Inactive state comprises a set of QoS identifiers;
the set of QoS identifiers comprises all QoS identifiers having a packet delay budget at or below a packet delay threshold;
the set of QoS identifiers comprises all QoS identifiers having a predetermined value;
detecting an expiration of a second inactivity timer for a second UE;
determining that the second UE supports the RRC Inactive state;
determining that the second UE does not have an ongoing packet session meeting selection criteria for the RRC Inactive state;
based on at least the second UE not having an ongoing packet session meeting the selection criteria for the RRC Inactive state, and further based on at least the expiration of the second inactivity timer, instructing the second UE, by the first base station, to enter an RRC Idle state;
performing a cell reselection of the first UE from the first base station to a second base station;
based on at least the first UE having been in the RRC Inactive state with the first base station, instructing the first UE, by the second base station, to enter the RRC Inactive state;
instructing the first UE to enter the RRC Inactive state comprises transmitting an RRC Release message with a suspendConfig instruction;
determining whether the first UE supports the RRC Inactive state;
determining whether the first UE has an ongoing packet session meeting selection criteria for the RRC Inactive state;
determining whether the first base station has capacity to support the first UE in the RRC Inactive state;
determining whether the second base station has capacity to support the first UE in the RRC Inactive state;
the packet session comprises a PDU session;
the set of QoS identifiers comprises 5QI values;
the set of QoS identifiers comprises QCI values;
the packet delay threshold is 50 ms or 100 ms;
the QoS identifiers having predetermined values are identified in an RRC Inactive state selection list;
the QoS identifiers having predetermined values comprise QoS identifiers designated as mission critical; and
the QoS identifiers having predetermined values comprise QoS identifiers designated for use by autonomous vehicles and/or V2X communication.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of wireless communication, the method comprising:
detecting an expiration of a first inactivity timer for a first user equipment (UE);
determining that the first UE supports a radio resource control (RRC) Inactive state;
determining that the first UE has an ongoing packet session meeting selection criteria for the RRC Inactive state; and
based on at least the first UE supporting the RRC Inactive state and the first UE having the ongoing packet session meeting the selection criteria for the RRC Inactive state, and further based on at least the expiration of the first inactivity timer, instructing the first UE, by a first base station serving the first UE, to enter the RRC Inactive state.

2. The method of claim 1, further comprising:
determining that the first base station has capacity to support the first UE in the RRC Inactive state, wherein instructing the first UE to enter the RRC Inactive state is further based on at least the first base station having capacity to support the first UE in the RRC Inactive state.

3. The method of claim 1, wherein the selection criteria for the RRC Inactive state comprises a set of quality of service (QoS) identifiers.

4. The method of claim 3, wherein the set of QoS identifiers comprises all QoS identifiers having a packet delay budget at or below a packet delay threshold, and/or all QoS identifiers having a predetermined value.

5. The method of claim 1, further comprising:
detecting an expiration of a second inactivity timer for a second UE;
determining that the second UE supports the RRC Inactive state;
determining that the second UE does not have an ongoing packet session meeting selection criteria for the RRC Inactive state; and
based on at least the second UE not having an ongoing packet session meeting the selection criteria for the RRC Inactive state, and further based on at least the expiration of the second inactivity timer, instructing the second UE, by the first base station, to enter an RRC Idle state.

6. The method of claim 1, further comprising:
performing a cell reselection of the first UE from the first base station to a second base station; and
based on at least the first UE having been in the RRC Inactive state with the first base station, instructing the first UE, by the second base station, to enter the RRC Inactive state.

7. The method of claim 1, wherein instructing the first UE to enter the RRC Inactive state comprises transmitting an RRC Release message with a suspendConfig instruction.

8. A system comprising:
a processor; and
a computer-readable medium storing instructions that are operative upon execution by the processor to:
detect an expiration of a first inactivity timer for a first user equipment (UE);
determine that the first UE supports a radio resource control (RRC) Inactive state;
determine that the first UE has an ongoing packet session meeting selection criteria for the RRC Inactive state; and
based on at least the first UE supporting the RRC Inactive state and the first UE having the ongoing packet session meeting the selection criteria for the RRC Inactive state, and further based on at least the expiration of the first inactivity timer, instruct the first UE, by a first base station serving the first UE, to enter the RRC Inactive state.

9. The system of claim 8, wherein the instructions are further operative to:
determine that the first base station has capacity to support the first UE in the RRC Inactive state, wherein instructing the first UE to enter the RRC Inactive state is further based on at least the first base station having capacity to support the first UE in the RRC Inactive state.

10. The system of claim 8, wherein the selection criteria for the RRC Inactive state comprises a set of quality of service (QoS) identifiers.

11. The system of claim 10, wherein the set of QoS identifiers comprises all QoS identifiers having a packet delay budget at or below a packet delay threshold, and/or all QoS identifiers having a predetermined value.

12. The system of claim 8, wherein the instructions are further operative to:
detect an expiration of a second inactivity timer for a second UE;
determine that the second UE supports the RRC Inactive state;
determine that the second UE does not have an ongoing packet session meeting selection criteria for the RRC Inactive state; and
based on at least the second UE not having an ongoing packet session meeting the selection criteria for the RRC Inactive state, and further based on at least the expiration of the second inactivity timer, instruct the second UE, by the first base station, to enter an RRC Idle state.

13. The system of claim 8, wherein the instructions are further operative to:
perform a cell reselection of the first UE from the first base station to a second base station; and
based on at least the first UE having been in the RRC Inactive state with the first base station, instruct the first UE, by the second base station, to enter the RRC Inactive state.

14. The system of claim 8, wherein instructing the first UE to enter the RRC Inactive state comprises transmitting an RRC Release message with a suspendConfig instruction.

15. One or more computer storage devices having computer-executable instructions stored thereon, which, upon execution by a computer, cause the computer to perform operations comprising:
detecting an expiration of a first inactivity timer for a first user equipment (UE);
determining that the first UE supports a radio resource control (RRC) Inactive state;
determining that the first UE has an ongoing packet session meeting selection criteria for the RRC Inactive state; and
based on at least the first UE supporting the RRC Inactive state and the first UE having the ongoing packet session meeting the selection criteria for the RRC Inactive state, and further based on at least the expiration of the first inactivity timer, instructing the first UE, by a first base station serving the first UE, to enter the RRC Inactive state.

16. The one or more computer storage devices of claim 15, wherein the operations further comprise:
determining that the first base station has capacity to support the first UE in the RRC Inactive state, wherein instructing the first UE to enter the RRC Inactive state is further based on at least the first base station having capacity to support the first UE in the RRC Inactive state.

17. The one or more computer storage devices of claim 15, wherein the selection criteria for the RRC Inactive state comprises a set of quality of service (QoS) identifiers.

18. The one or more computer storage devices of claim 17, wherein the set of QoS identifiers comprises all QoS identifiers having a packet delay budget at or below a packet delay threshold, and/or all QoS identifiers having a predetermined value.

19. The one or more computer storage devices of claim 15, wherein the operations further comprise:
detecting an expiration of a second inactivity timer for a second UE;
determining that the second UE supports the RRC Inactive state;
determining that the second UE does not have an ongoing packet session meeting selection criteria for the RRC Inactive state; and
based on at least the second UE not having an ongoing packet session meeting the selection criteria for the RRC Inactive state, and further based on at least the expiration of the second inactivity timer, instructing the second UE, by the first base station, to enter an RRC Idle state.

20. The one or more computer storage devices of claim 15, wherein the operations further comprise:
performing a cell reselection of the first UE from the first base station to a second base station; and
based on at least the first UE having been in the RRC Inactive state with the first base station, instructing the first UE, by the second base station, to enter the RRC Inactive state.
